(19) United States
(12) Patent Application Publication
(10) Pub. No.: US 2011/0222207 A1
(43) Pub. Date: Sep. 15, 2011

(54) Methods of forming a dielectric layer structure, and methods of manufacturing a capacitor using the same

(76) Inventors: Tae-Jong Lee, Suwon-si (KR); Jae-Young Park, Yongin-si (KR); Jong-Bom Seo, Seoul (KR); Seok-Woo Nam, Seongnam-si (KR); Bong-Hyun Kim, Incheon (KR); Han-Jin Lim, Seoul (KR); Seung-Sik Chung, Seoul (KR)

(21) Appl. No.: 13/064,241

(22) Filed: Mar. 14, 2011

(30) Foreign Application Priority Data
Mar. 15, 2010 (KR) 10-2010-0022640

(51) Int. Cl. H01G 4/10; H01G 7/00; B05D 5/12

(52) U.S. Cl. 361/322; 29/25.41; 427/126.3; 427/126.4; 427/576

(57) ABSTRACT

In a method of forming a dielectric layer structure, a precursor thin film chemisorbed on a substrate in a process chamber is formed using a source gas including a metal precursor. The process chamber is purged and pumped out to remove a remaining source gas therein and to remove any metal precursor physisorbed on the precursor thin film. The forming of the precursor thin film and the purging and pumping out of the process chamber are alternately and repeatedly performed to form a multi-layer precursor thin film. An oxidant is provided onto the multilayer precursor thin film to form a bulk oxide layer.

### BACKGROUND

1. Field

Example embodiments relate to methods of forming a dielectric structure, methods of manufacturing a capacitor using the same and capacitors. More particularly, example embodiments relate to methods of forming a dielectric structure by an atomic layer deposition (ALD) process, methods of manufacturing a capacitor using the same and capacitors.

2. Description of the Related Art

As semiconductor devices have been highly integrated, various methods for realizing a high cell capacitance within a limited area have been developed. For example, a dielectric layer of a capacitor may be formed using a material having a high dielectric constant. The dielectric layer including a high-k material may be formed by an ALD process in consideration of the high step coverage and the electrical characteristics thereof.

### SUMMARY

According to an example embodiment, there is provided a method of forming a dielectric layer structure, including forming a precursor thin film chemisorbed on a substrate in a process chamber, using a source gas including a metal precursor, carrying out a first purging and pumping out of the process chamber to remove a remaining source gas in the process chamber and to remove any metal precursor that may be physisorbed on the precursor thin film, alternately and repeatedly performing the forming of the precursor thin film and the first purging and pumping out of the process chamber to form a multi-layer precursor thin film, and providing an oxidant onto the multi-layer precursor thin film to form a bulk oxide layer.

The method may further include forming a dielectric layer on the bulk oxide layer, wherein the bulk oxide layer and the dielectric layer form the dielectric layer structure.

The method may further include forming a dielectric layer on the bulk oxide layer and then alternately forming at least one additional bulk oxide layer and one additional dielectric layer to form a stacked structure of alternating bulk oxide layers and dielectric layers, wherein the stacked structure forms the dielectric layer structure.

The dielectric layer may be formed by an atomic layer deposition (ALD) process using at least one of hafnium oxide, aluminum oxide, zirconium oxide, titanium oxide, tantalum oxide, lanthanum oxide, praseodymium oxide, tungsten oxide, niobium oxide, molybdenum oxide, strontium oxide and barium oxide.

The precursor thin film may be formed to have a single atomic layer, and the bulk oxide layer may be formed to have a plurality of atomic layers.

The method may further include carrying out a second purging and pumping out of the process chamber after the providing of the oxidant to remove any remaining oxidant in the process chamber.

The second purging and pumping out of the process chamber may be repeatedly performed.

The source gas may include any one of Hf(OtBu)₄, tetrakis ethyl methyl amino hafnium (TEMAH), tetrakis di-methyl amino hafnium (TDMAH) and tetrakis di-ethyl amino hafnium (TDEAH).

The source gas may include any one of Zr(OtBu)₄, tetrakis ethyl methyl amino zirconium (TEMAZ), tetrakis di-methyl amino zirconium (TDMAZ) and tetrakis di-ethyl amino zirconium (TDEAZ).

The source gas may include tri methyl aluminum (TMA).

The oxidant includes any one of O₃, H₂O, O₂, N₂O and O₂ plasma.

The method may be performed with respect to a plurality of substrates arranged in the process chamber.

The method may further include performing a plasma treatment on the bulk oxide layer.

The plasma treatment may be performed under an atmosphere including at least one of O₂ plasma, N₂ plasma, NH₃ plasma and N₂O plasma.

The first purging and pumping out of the process chamber may include providing a purge gas into the process chamber and pumping out the process chamber; and pumping out the process chamber without providing a purge gas.

According to another example embodiment, there is provided a method of manufacturing a capacitor, including forming a lower electrode on a substrate in a process chamber, forming an atomic-sized metal precursor thin film chemisorbed on the lower electrode using a source gas including a metal precursor, carrying out a first purging and pumping out of the process chamber to remove a remaining source gas in the process chamber and to remove any metal precursor physisorbed on the metal precursor thin film, alternately and repeatedly performing the forming of the precursor thin film and the first purging and pumping out of the process chamber to form a multi-layer precursor thin film, providing an oxidant onto the multi-layer metal precursor thin film to form a bulk oxide layer, forming a dielectric layer on the bulk oxide layer; and forming an upper electrode on the dielectric layer.

The lower and upper electrodes may be formed using at least one of titanium nitride, tungsten nitride, tantalum nitride, ruthenium, platinum and iridium.

The dielectric layer may be formed by an ALD process using at least one of hafnium oxide, aluminum oxide, zirconium oxide, titanium oxide, tantalum oxide, lanthanum oxide, praseodymium oxide, tungsten oxide, niobium oxide, molybdenum oxide, strontium oxide and barium oxide.

The method may further include carrying out a second purging and pumping out of the process chamber after the providing to the oxidant to remove any remaining oxidant in the process chamber.

The method may further include alternately forming at least one additional bulk oxide layer and at least one additional dielectric layer.

According to another example embodiment, there is provided a capacitor including a lower electrode, a dielectric layer structure on the lower electrode, including a bulk oxide layer having a plurality of atomic layers; and a dielectric layer on the bulk oxide layer, wherein the bulk oxide layer has a higher degree of crystallization than that of the dielectric layer, and an upper electrode on the dielectric layer.

The lower electrode may have a cylindrical shape, and the dielectric layer structure may be conformally formed on the lower electrode.

The dielectric layer structure may include crystalline hafnium oxide, crystalline zirconium oxide or crystalline aluminum oxide.

The dielectric layer structure may have a thickness equal to or less than about 60 Å.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a flowchart illustrating a method of forming a dielectric structure in accordance with example embodiments;

FIGS. 2 to 8 illustrate cross-sectional views illustrating a method of forming a dielectric structure in accordance with example embodiments;

FIGS. 9 to 10 illustrate cross-sectional views illustrating a method of manufacturing a capacitor in accordance with example embodiments;

FIGS. 11 to 15 illustrate cross-sectional views illustrating a method of manufacturing a capacitor in accordance with other example embodiments;

FIG. 16 illustrates a graph illustrating the relationships between capacitances and off voltages of first and second capacitors having the first and second dielectric layer structures, respectively; and

FIG. 17 illustrates a graph illustrating leakage currents through the dielectric layer structures when a voltage is repeatedly applied to the dielectric layer structures.

### DETAILED DESCRIPTION

Korean Patent Application No. 10-2010-0022640, filed on Mar. 15, 2010, in the Korean Intellectual Property Office, and entitled: “Methods of Forming a Dielectric Layer Structure, Methods of Manufacturing a Capacitor Using the Same and Capacitors,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

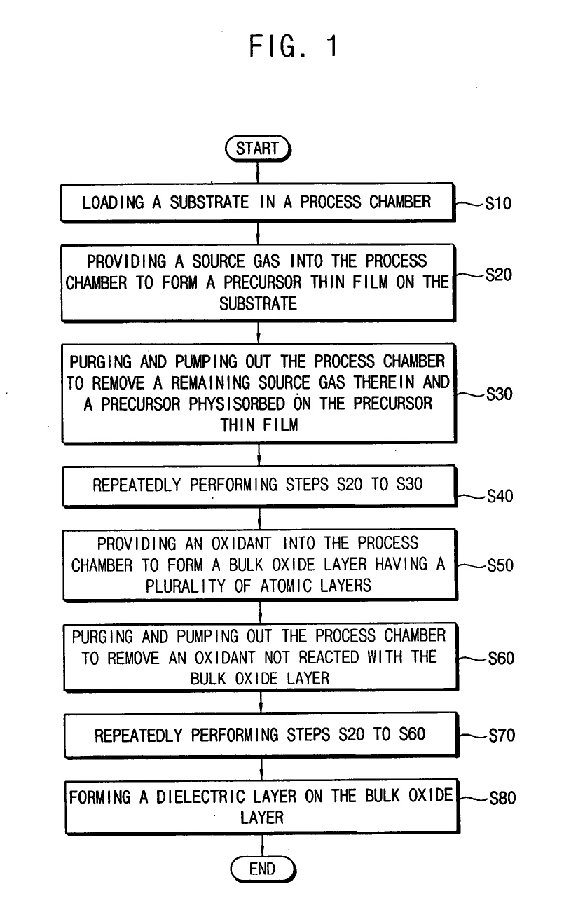

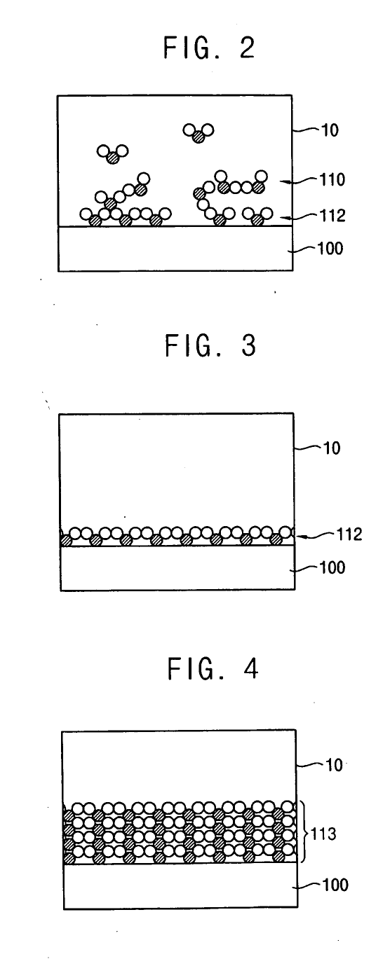

FIG. 1 is a flowchart illustrating a method of forming a dielectric structure in accordance with example embodiments. FIGS. 2 to 8 are cross-sectional views illustrating a method of forming a dielectric structure in accordance with example embodiments.

Referring to FIGS. 1 and 2, in S10, a substrate 100 is loaded into a process chamber 10. In an example embodiment, a plurality of substrates 100 may be loaded into the process chamber 10 for the efficiency of processes. The process chamber 10 may have a furnace extending in a vertical direction, and the substrates 100 loaded into the process chamber 10 may be supported by a boat (not shown). The substrate 100 may include, for example, a silicon wafer having a large diameter of about 300 mm.

A various types of structures (not shown) may be formed on the substrate 100. For example, a conductive layer (not shown) including a metal, a metal nitride, a metal silicide, a metal oxide, etc., or an electrode (not shown), an insulation layer (not shown), etc. may be formed thereon.

In S20, a source gas 110 including a metal precursor may be provided onto the substrate 100 loaded in the process chamber 10. In an example embodiment, the source gas 110 may be vaporized by a bubbler and provided into the process chamber 10 in a gaseous state.

The source gas 110 may include a metal precursor gas including a metal such as zirconium, hafnium, aluminum, etc. For example, the source gas 110 may include a zirconium precursor gas such as Zr(OtBu)₄, tetrakis ethyl methyl amino zirconium (TEMAZ), tetrakis di-methyl amino zirconium (TDMAZ) or tetrakis di-ethyl amino zirconium (TDEAZ), a hafnium precursor gas such as Hf(OtBu)₄, tetrakis ethyl methyl amino hafnium (TEMAH), tetrakis di-methyl amino hafnium (TDMAH) or tetrakis di-ethyl amino hafnium (TDEAH), or aluminum precursor gas such as tri methyl aluminum (TMA).

In an example embodiment, the source gas 110 may be provided into the process chamber 10 by a carrier gas (not shown). The carrier gas may include an inactive gas such as argon, helium, krypton, xenon, etc. These may be used alone or in a combination thereof.

A portion of the metal precursor included in the source gas 110 provided onto the substrate 100 may be chemisorbed on a top surface of the substrate 100 to form a metal precursor thin film 112 that is layer having an atomic thickness. Other portions of the metal precursor may be physisorbed on the portion of the metal precursor chemisorbed on the top surface of the substrate 100 or may drift in the process chamber 10.

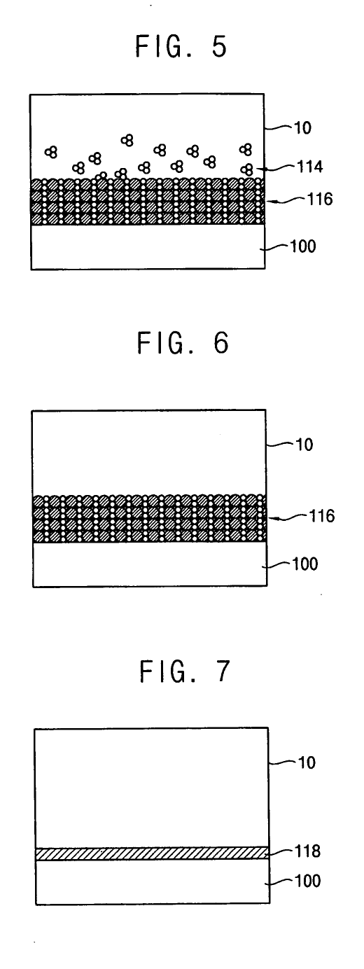

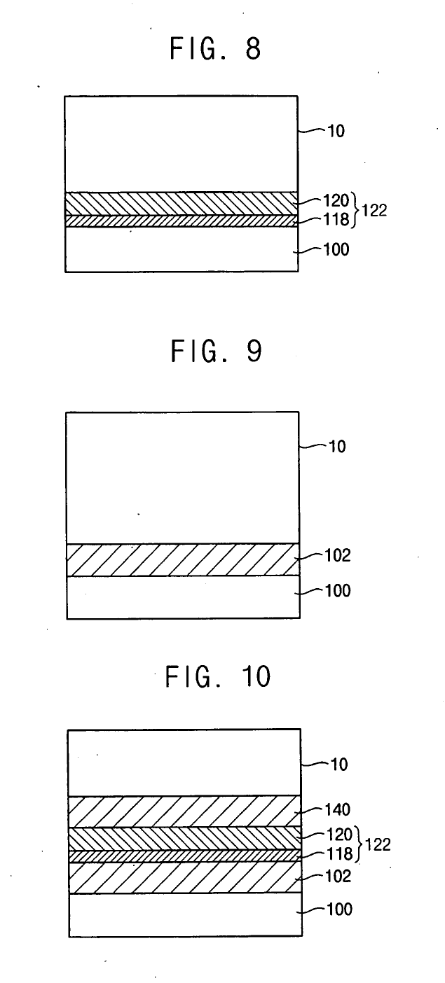

If an internal temperature of the process chamber 10 is below about 200° C., the source gas 110 and an oxidant 114 (see FIG. 5) subsequently provided may not have good reactivity. If the internal temperature of the process chamber 10 is above about 400° C., a dielectric layer 120 (see FIG. 8) may be crystallized and the deposition process may have chemical vapor deposition (CVD) characteristics rather than ALD characteristics. Thus, in example embodiments, the internal temperature of the process chamber 10 may be in a range of about 200 to about 400° C. so that the dielectric layer 120 may be formed by an ALD process. The deposition process may have good ALD characteristics at a temperature of about 300° C., and thus the internal temperature of the process chamber 10 may be, preferably, about 300° C.

Referring to FIGS. 1 and 3, in S30, a first purge gas (not shown) may be provided into the process chamber 10, and the process chamber 10 may be pumped out, so that the portions of the metal precursor that are not chemisorbed on the top surface of the substrate 100 or that are drifting in the process chamber 10 may be removed from the process chamber 10. Accordingly, the source gas 110 drifting in the process chamber 10 may be removed from the process chamber 10 together with the first purge gas, and the portions of the metal precursor that are physisorbed on the portion of the metal precursor chemisorbed on the top surface of the substrate 100 may be also removed. After the providing of the first purge gas is stopped, the process chamber 10 may be pumped out in a high-degree vacuum, and the physisorbed metal precursor may be removed.

Alternatively, before removing the remaining source gas 110 while providing the first purge gas and pumping out the process chamber 10, the physisorbed metal precursor may be first removed by pumping out the process chamber 10 after the providing of the first purge gas is stopped.

Referring to FIGS. 1 and 4, S20 and S30 may be repeatedly performed to form a metal precursor layer 113 having a plurality of atomically thick layers. Thus, the metal precursor layer 113 may have a desired thickness.

Referring to FIGS. 1 and 5, in S50, the oxidant 114 may be provided into the process chamber 10 to oxidize the metal precursor layer 113, so that a bulk oxide layer 116 having a plurality of atomically thick layers may be formed. The oxidant 114 may include, for example, O₃, H₂O, O₂, N₂O, O₂ plasma, etc.

Referring to FIGS. 1 and 6, in S60, a second purge gas (not shown) may be provided into the process chamber 10, and the process chamber 10 may be pumped out, so that the oxidant 114 remaining in the process chamber 10 may be removed. In an example embodiment, the second purge gas may be substantially the same as the first purge gas. After stopping the providing of the second purge gas, the process chamber 10 may be pumped out. Alternatively, before removing the remaining oxidant 114 while providing the second purge gas and pumping the process chamber 10 out, the process chamber 10 may be pumped out after stopping the providing of the second purge gas. In example embodiments, providing the second purge gas and pumping the process chamber 10 out may be repeatedly performed to sufficiently remove the oxidant 114.

Referring to FIGS. 1 and 7, S20 to S60 may be repeatedly performed to form a bulk oxide layer 118 having a desired thickness on the substrate 100.

Meanwhile, before providing the source gas 110 or the oxidant 114 into the process chamber 10, a pre-flushing process may be further performed on the source gas 110 or the oxidant 114, so that the source gas 110 or the oxidant 114 may have laminar flow characteristics.

After forming the bulk oxide layer 118, a plasma treatment or a heat treatment may be further performed on the bulk oxide layer 118, thereby enhancing the electrical characteristics thereof. That is, the bulk oxide layer 118 may be densified by the plasma treatment or the heat treatment, so that the leakage current thereof may be decreased.

The plasma treatment may be performed under an O₂ plasma atmosphere, an N₂ plasma atmosphere, an NH₃ plasma atmosphere, an N₂O plasma atmosphere or an NO₂ plasma atmosphere, and the heat treatment may be performed under an O₂ atmosphere or an O₃ atmosphere.

Referring to FIGS. 1 and 8, in S80, the dielectric layer 120 may be formed on the bulk oxide layer 118. In example embodiments, the dielectric layer 120 may be formed by an ALD process. The dielectric layer 120 may be formed using a high-k material such as a metal oxide. For example, the high-k material may include hafnium oxide, aluminum oxide, zirconium oxide, titanium oxide, tantalum oxide, lanthanum oxide, praseodymium oxide, tungsten oxide, niobium oxide, molybdenum oxide, strontium oxide, barium oxide, etc. These may be used alone or in a combination thereof. Thus, the dielectric layer 120 may have a single-layered structure including the above material or a multi-layered structure, e.g., hafnium oxide layer/aluminum oxide layer, zirconium oxide layer/aluminum oxide layer, hafnium oxide layer/aluminum oxide layer/hafnium oxide layer, zirconium oxide layer/aluminum oxide layer/zirconium oxide layer, etc.

By the above-illustrated processes, a dielectric layer structure 122 including the bulk oxide layer 118 and the dielectric layer 120 may be formed. In example embodiments, the dielectric layer structure 122 may be formed to have a thickness equal to or less than about 60 Å.

In example embodiments, the dielectric layer structure 122 may include the bulk oxide layer 118, which may be formed by repeatedly performing the providing of the source gas 110 on the substrate 100 in the process chamber 10 and the purging of the process chamber 10 and by providing the oxidant 114 on the substrate 100. Thus, the bulk oxide layer 118 may have a good layer quality as a seed layer for forming the dielectric layer 120 and may have a high degree of crystallization. Additionally, the bulk oxide layer 118 may have a low interface stress between itself and the dielectric layer 120. Thus, the dielectric layer structure 122 including the bulk oxide layer 118 and the dielectric layer 120 may have a high dielectric constant and a high step coverage. The term “step coverage” refers to a degree to which a layer is conformally deposited on a structure. For example, the term “step coverage” may refer to a thickness ratio of a portion of a layer on a bottom of a hole with respect to a portion of the layer on an insulation layer having the hole therethrough, or a thickness ratio of a portion of a layer on a sidewall of a step structure with respect to a portion of the layer on a top surface of the step structure.

FIGS. 9 to 10 are cross-sectional views illustrating a method of manufacturing a capacitor in accordance with example embodiments. In the method of manufacturing the capacitor, the method of forming the dielectric layer illustrated with reference to FIGS. 1 to 8 may be used. Thus, like reference numerals refer to like elements, and repetitive explanations are omitted here.

Referring to FIG. 9, a lower electrode 102 may be formed on a substrate 100. In an example embodiment, the lower electrode 102 may be formed using a metal or a metal nitride. For example, the lower electrode 102 may be formed using a noble metal such as ruthenium, platinum, iridium, etc., or a metal nitride such as titanium nitride, tungsten nitride, tantalum nitride, etc. The lower electrode 102 may be formed by a CVD process, an ALD process, and the like. In example embodiments, the lower electrode 102 may be formed to have a cylindrical shape.

Referring to FIG. 10, a dielectric layer structure 122 may be formed on the lower electrode 102. The dielectric layer structure 122 may include a bulk oxide layer 118 and a dielectric layer 120, and may be formed by processes substantially the same as those illustrated with reference to FIGS. 1 to 8.

In example embodiments, the dielectric structure 122 may be formed to have a thickness equal to or less than about 60 Å. If only the dielectric layer 120 having a thickness equal to or less than about 60 Å were to be formed without forming the bulk oxide layer 118, the dielectric layer 120 may not have a crystalline structure but may instead have an amorphous structure. Particularly, if the dielectric layer 120 were to be formed on the cylindrical lower electrode 102 having a high aspect ratio, a portion of the dielectric layer 120 on a bottom of the lower electrode 102 may have a small thickness, and thus the dielectric layer 120 may have less of a crystalline structure. In order to solve that problem, if the dielectric layer 120 were to be formed to have a larger thickness, the entrance of the cylindrical lower electrode 102 may be blocked during the formation of the dielectric layer 120, thereby forming a void.

However, the dielectric layer structure 122 in accordance with example embodiments may include the bulk oxide layer 118, which has a higher degree of crystallization than the dielectric layer 120, thereby providing a crystalline structure at a smaller thickness.

Additionally, the dielectric layer structure 122 may have low stress between an upper electrode 140 (see FIG. 10) subsequently formed.

Referring to FIG. 10, the upper electrode 140 may be formed on the dielectric layer structure 122. The upper electrode 140 may be formed using a material substantially the same as that of the lower electrode 102.

Thus, a capacitor having the lower electrode 102, the dielectric layer structure 122 and the upper electrode 140 may be manufactured.

The capacitor may include the dielectric layer structure 122 including the bulk oxide layer 118, and thus may have good electrical characteristics, such as a high capacitance, a low leakage current, and the like.

Particularly, the bulk oxide layer 118 may have a high degree of crystallization at a relatively small thickness, and thus the capacitor may have a high capacitance even if the capacitor includes the cylindrical lower electrode 102 having a high aspect ratio.

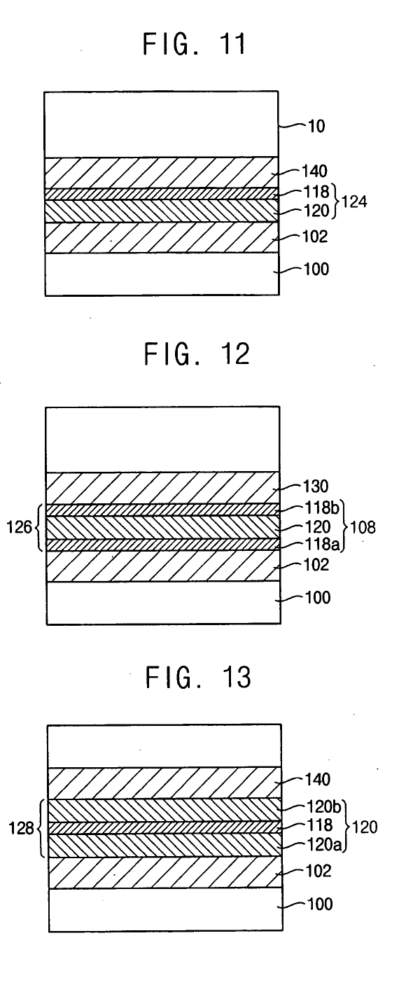

FIGS. 11 to 15 are cross-sectional views illustrating a method of manufacturing a capacitor in accordance with other example embodiments. In FIGS. 11 to 15, the capacitors may have various shapes of dielectric layer structures, and all elements except for the dielectric layer structures may be substantially the same as or similar to each other. The dielectric layer structures may be formed by a method substantially the same as the method of forming the dielectric layer illustrated with reference to FIGS. 1 to 8, except for the order of forming the bulk oxide layer and the dielectric layer and the locations thereof may vary. Thus, specific methods of forming the dielectric layer structures are not explained, and only the final dielectric layer structures are shown here.

Referring to FIG. 11, a dielectric layer 120 and a bulk oxide layer 118 may be sequentially formed on a lower electrode 102 to form a dielectric layer structure 124.

Referring to FIG. 12, a first bulk oxide layer 118a, a dielectric layer 120 and a second bulk oxide layer 118b may be sequentially formed on a lower electrode 102 to form a dielectric layer structure 126.

Referring to FIG. 13, a first dielectric layer 120a, a bulk oxide layer 118 and a second dielectric layer 120b may be sequentially formed on a lower electrode 102 to form a dielectric layer structure 128.

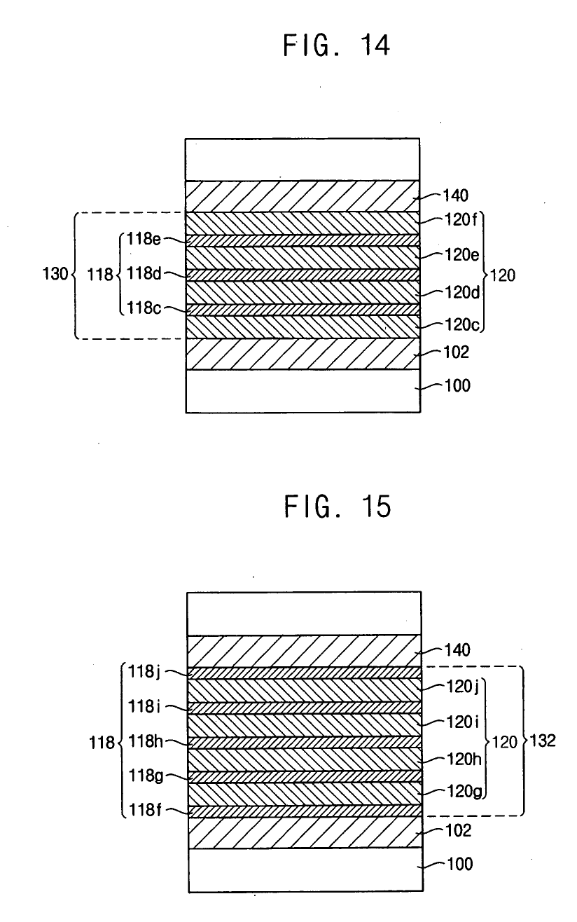

Referring to FIG. 14, third to sixth dielectric layers 120c, 120d, 120e and 120f and third to fifth bulk oxide layers 118c, 118d and 118e may be alternately and sequentially formed on a lower electrode 102 to form a dielectric layer structure 130.

Referring to FIG. 15, sixth to tenth bulk oxide layers 118f, 118g, 118h, 118i and 118j and seventh to tenth dielectric layers 120g, 120h, 120i and 120j may be alternately and sequentially formed on a lower electrode 102 to form a dielectric layer structure 132.

The dielectric layer structure in accordance with example embodiments may not be limited to those illustrated with reference to FIGS. 11 to 15, and a plurality of bulk oxide layers and a plurality of dielectric layers may be formed on a lower electrode in various configurations, thereby providing a desired thickness and a desired capacitance.

### Evaluation of Characteristics of a Dielectric Layer

A first dielectric layer structure having zirconium oxide layer/aluminum oxide layer/zirconium oxide layer was formed by a conventional ALD process.

A second dielectric layer structure was formed by the method in accordance with example embodiments, which includes repeatedly performing the forming of a metal precursor thin film, purging and pumping out the process chamber, providing an oxidant to form a bulk oxide layer and forming a dielectric layer having zirconium oxide layer/aluminum oxide layer/zirconium oxide layer. Particularly, the process of forming the metal precursor thin film, the process of purging and the process of pumping the process chamber were performed 10 times forming the forming of the bulk oxide layer, and processes substantially the same as those for forming the first dielectric layer structure except for forming the bulk oxide layer were performed.

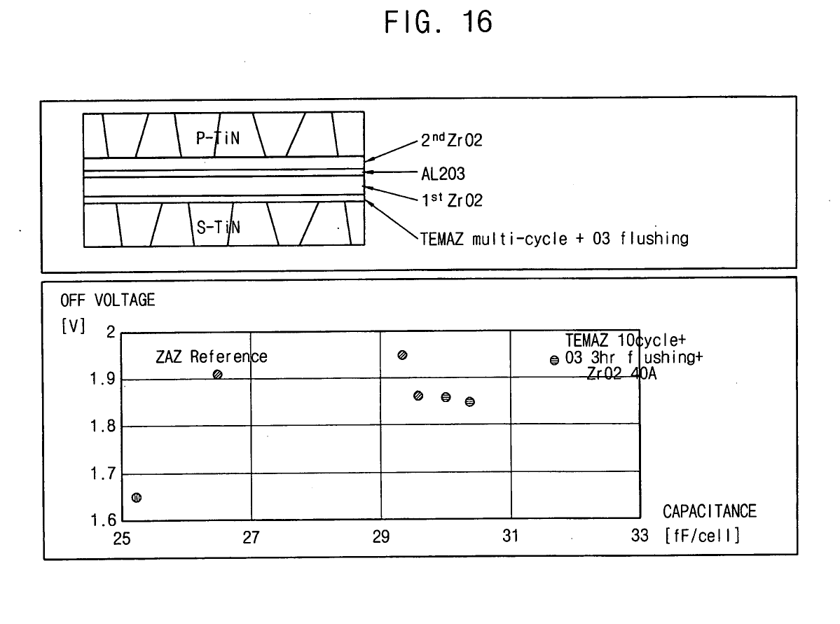

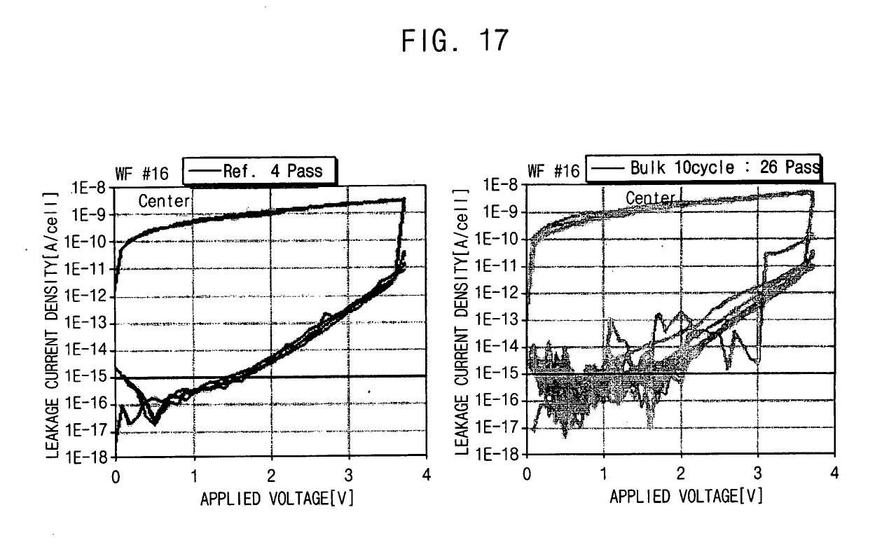

FIG. 16 is a graph illustrating the relationships between capacitances and off voltages of first and second capacitors having the first and second dielectric layer structures, respectively.

Referring to FIG. 16, both the off voltages of the first and second capacitors having the first and second dielectric layer structures were 1.9V. The second capacitor having the second dielectric layer structure had a capacitance higher than that of the first capacitor having the first dielectric layer structure by about 2 fF/cell to about 3 fF/cell. That is, the second capacitor had an enhanced capacitance when compared to the first capacitor.

FIG. 17 is a graph illustrating leakage currents through the dielectric layer structures when a voltage is repeatedly applied to the dielectric layer structures.

Referring to FIG. 17, when a voltage was repeatedly applied, the first dielectric layer structure was broken down at the fifth cycle, while the second dielectric layer structure was not broken down until the 26th cycle. That is, the second dielectric layer structure had enhanced leakage current characteristics when compared to the first dielectric layer structure.

By way of summary and review, according to example embodiments, a metal precursor layer having a plurality of atomic layers may be formed on a substrate in a process chamber by repeatedly performing providing a source gas into the process chamber to form a metal precursor thin film on the substrate and purging and pumping out the process chamber, and the metal precursor thin film may be oxidized to form a bulk oxide layer. A dielectric layer may be formed on the bulk oxide layer to form a dielectric layer structure having enhanced electrical characteristics and a high dielectric constant.

Thus, a capacitor including the dielectric layer structure may have a low leakage current and a high capacitance. Particularly, the bulk oxide layer may have a high degree of crystallization at a small thickness, and thus the capacitor including the dielectric layer structure may have a high capacitance when the capacitor has a cylindrical lower electrode.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

1. A method of forming a dielectric layer structure, comprising:
forming a precursor thin film chemisorbed on a substrate in a process chamber, using a source gas including a metal precursor;
carrying out a first purging and pumping out of the process chamber to remove a remaining source gas in the process chamber and to remove any metal precursor that may be physisorbed on the precursor thin film;
alternately and repeatedly performing the forming of the precursor thin film and the first purging and pumping out of the process chamber to form a multi-layer precursor thin film; and
providing an oxidant onto the multi-layer precursor thin film to form a bulk oxide layer.

2. The method as claimed in claim 1, further comprising forming a dielectric layer on the bulk oxide layer, wherein the bulk oxide layer and the dielectric layer form the dielectric layer structure.

3. The method as claimed in claim 1, further comprising forming a dielectric layer on the bulk oxide layer and then alternately forming at least one additional bulk oxide layer and one additional dielectric layer to form a stacked structure of alternating bulk oxide layers and dielectric layers, wherein the stacked structure forms the dielectric layer structure.

4. The method as claimed in claim 2, wherein the dielectric layer is formed by an atomic layer deposition (ALD) process using at least one of hafnium oxide, aluminum oxide, zirconium oxide, titanium oxide, tantalum oxide, lanthanum oxide, praseodymium oxide, tungsten oxide, niobium oxide, molybdenum oxide, strontium oxide and barium oxide.

5. The method as claimed in claim 1, wherein the precursor thin film is formed to have a single atomic layer, and the bulk oxide layer is formed to have a plurality of atomic layers.

6. The method as claimed in claim 1, further comprising carrying out a second purging and pumping out of the process chamber after the providing of the oxidant to remove any remaining oxidant in the process chamber.

7. The method as claimed in claim 6, wherein the second purging and pumping out of the process chamber is repeatedly performed.

8. The method as claimed in claim 1, wherein the source gas includes any one of Hf(OtBu)₄, tetrakis ethyl methyl amino hafnium (TEMAH), tetrakis di-methyl amino hafnium (TDMAH) and tetrakis di-ethyl amino hafnium (TDEAH).

9. The method as claimed in claim 1, wherein the source gas includes any one of Zr(OtBu)₄, tetrakis ethyl methyl amino zirconium (TEMAZ), tetrakis di-methyl amino zirconium (TDMAZ) and tetrakis di-ethyl amino zirconium (TDEAZ).

10. The method as claimed in claim 1, wherein the source gas includes tri methyl aluminum (TMA).

11. The method as claimed in claim 1, wherein the oxidant includes any one of O₃, H₂O, O₂, N₂O and O₂ plasma.

12. The method as claimed in claim 1, wherein the method is performed with respect to a plurality of substrates arranged in the process chamber.

13. The method as claimed in claim 1, further comprising performing a plasma treatment on the bulk oxide layer.

14. The method as claimed in claim 13, wherein the plasma treatment is performed under an atmosphere including at least one of O₂ plasma, N₂ plasma, NH₃ plasma and N₂O plasma.

15. The method as claimed in claim 1, wherein the first purging and pumping out of the process chamber includes:
providing a purge gas into the process chamber and pumping out the process chamber; and
pumping out the process chamber without providing a purge gas.

16. A method of manufacturing a capacitor, comprising:
forming a lower electrode on a substrate in a process chamber;
forming an atomic-sized metal precursor thin film chemisorbed on the lower electrode using a source gas including a metal precursor;
carrying out a first purging and pumping out of the process chamber to remove a remaining source gas in the process chamber and to remove any metal precursor physisorbed on the metal precursor thin film;
alternately and repeatedly performing the forming of the precursor thin film and the first purging and pumping out of the process chamber to form a multi-layer precursor thin film;
providing an oxidant onto the multi-layer metal precursor thin film to form a bulk oxide layer;
forming a dielectric layer on the bulk oxide layer; and
forming an upper electrode on the dielectric layer.

17. The method as claimed in claim 16, wherein the lower and upper electrodes are formed using at least one of titanium nitride, tungsten nitride, tantalum nitride, ruthenium, platinum and iridium.

18. The method as claimed in claim 16, wherein the dielectric layer is formed by an ALD process using at least one of hafnium oxide, aluminum oxide, zirconium oxide, titanium oxide, tantalum oxide, lanthanum oxide, praseodymium oxide, tungsten oxide, niobium oxide, molybdenum oxide, strontium oxide and barium oxide.

19. The method as claimed in claim 16, further comprising carrying out a second purging and pumping out of the process chamber after the providing to the oxidant to remove any remaining oxidant in the process chamber.

20. The method as claimed in claim 16, further including alternately forming at least one additional bulk oxide layer and at least one additional dielectric layer.

21.-24. (canceled)
